(19) United States
(12) Patent Application Publication
(10) Pub. No.: US 2012/0136857 A1
(43) Pub. Date: May 31, 2012

(54) METHOD AND APPARATUS FOR SELECTIVELY PERFORMING EXPLICIT AND IMPLICIT DATA LINE READS

(75) Inventor: Greggory D. Donley, San Jose, CA (US)

(73) Assignee: ADVANCED MICRO DEVICES, INC., Sunnyvale, CA (US)

(21) Appl. No.: 12/956,151

(22) Filed: Nov. 30, 2010

(51) Int. Cl. G06F 17/30

(52) U.S. Cl. 707/733; 707/734; 707/E17.059

(57) ABSTRACT

A method and apparatus are described for selectively performing explicit and implicit data line reads. When a data line request is received, a determination is made as to whether there are currently sufficient data resources to perform an implicit data line read. If there are not currently sufficient data resources to perform an implicit data line read, a time period (number of clock cycles) before sufficient data resources will become available to perform an implicit data line read is estimated. A determination is then made as to whether the estimated time period exceeds a threshold. An explicit tag request is generated if the estimated time period exceeds the threshold. If the estimated time period does not exceed the threshold, the generation of a tag request is delayed until sufficient data resources become available. An implicit tag request is then generated.

### FIELD OF INVENTION

This application is related to a cache in a semiconductor device (e.g., an integrated circuit (IC)).

### BACKGROUND

In a typical processor, a plurality of processing cores, (e.g., central processing unit (CPU) cores, graphics processing unit (GPU) cores, and the like), retrieve data from a cache (e.g., a data cache) by sending data line requests to the cache. FIG. 1 shows a conventional processor including a plurality of processing cores 1051-105N, a data cache 110 and data buffers 1151-115N. The data cache 110 includes a controller 120 and sub-cache units 1251-125N. The controller 120 includes a data line tag request generation unit 130 and a resource analyzer 135.

The data line tag generation unit 130 is configured to output a data line tag request in response to the controller 120 in the data cache 110 receiving a data line request 140 from any of the processing cores 105. The data line tag request may consist of an address of a requested data line and an indicator (e.g., represented by one or more bits) of whether the tag request is an implicit tag request or an explicit tag request. An implicit tag request enables a requested data line to be accessed immediately without delay by performing an implicit data line read, if the requested data line is stored in the data cache 125. An explicit tag request requires the controller 120 to perform an additional step of sending a data request to a sub-cache unit 125 in order to access a requested data line by performing an explicit data line read, if a tag response is received that indicates the data line is present.

The resource analyzer 135 monitors data resources and constantly indicates to the data line tag request generation unit 130 via a signal 138 whether or not there are currently sufficient data resources to immediately generate a tag request with an implicit indicator to perform an implicit data line read. If there are not sufficient data resources, the data line tag request generation unit 130 issues an explicit tag request 150 to a respective sub-cache unit 125, which responds by sending a tag response 155 to the controller. If the tag response indicates that the requested data line is stored in the data cache 125, (i.e., a “tag hit”), the controller 120 must send a data request 160 to the sub-cache unit 125 to retrieve the requested data line (i.e., schedule a data line read). The sub-cache unit 125 responds by sending a data response 165 to the controller 120, and sending the accessed data line 170 to a data buffer 115. The data line 170 can then be read by the processing core 105.

If there are sufficient data resources, the data line tag request generation unit 130 issues an implicit tag request 180 to a respective sub-cache unit 125, which responds by sending a tag response 185 to the controller 120 and performing an implicit data line read. The sub-cache unit 125 sends the accessed data line 190 to a data buffer 115. The data line 190 can then be read by the processing core 105.

When tags in a sub-cache unit 125 are accessed to determine whether a data line is contained in data-cache 110, waiting for a tag hit to be determined before starting the data access (i.e., by using an explicit tag request) results in higher latency. However, starting the data access immediately without waiting for the tag hit determination (i.e., by using an implicit tag request) requires data resources to be reserved in advance, which are then wasted if the tag access results in a “tag miss” (i.e., the requested data line is not stored in the data cache 125). The controller 120 switches between explicit and implicit tag request modes based on the instantaneous availability of data resources, when the data line tag request generation unit 130 sends the tag request to the sub-cache unit 125.

There is a substantial difference in latency (i.e., 10-12 clock cycles) between retrieving data using an explicit data line read and retrieving data using an implicit data line read. Generating implicit tag requests is more beneficial than generating explicit tag requests because they take less time to perform, thus reducing latency. Thus, it would be desirable to be maximizing the use of implicit tag requests.

### SUMMARY OF EMBODIMENTS OF THE PRESENT INVENTION

A method and apparatus are described for selectively performing explicit and implicit data line reads. When a data line request is received, a determination is made as to whether there are currently sufficient data resources to perform an implicit data line read. If there are not currently sufficient data resources to perform an implicit data line read, a time period (e.g., a number of clock cycles) before sufficient data resources will become available to perform an implicit data line read is estimated. A determination is then made as to whether the estimated time period exceeds a threshold. An explicit tag request is generated if the estimated time period exceeds the threshold. If the estimated time period does not exceed the threshold, the generation of a tag request is delayed until sufficient data resources become available. An implicit tag request is then generated.

### BRIEF DESCRIPTION OF THE DRAWINGS

A more detailed understanding may be had from the following description, given by way of example in conjunction with the accompanying drawings wherein:

FIG. 1 shows a processor that generates explicit and implicit data line tag requests in a conventional manner;

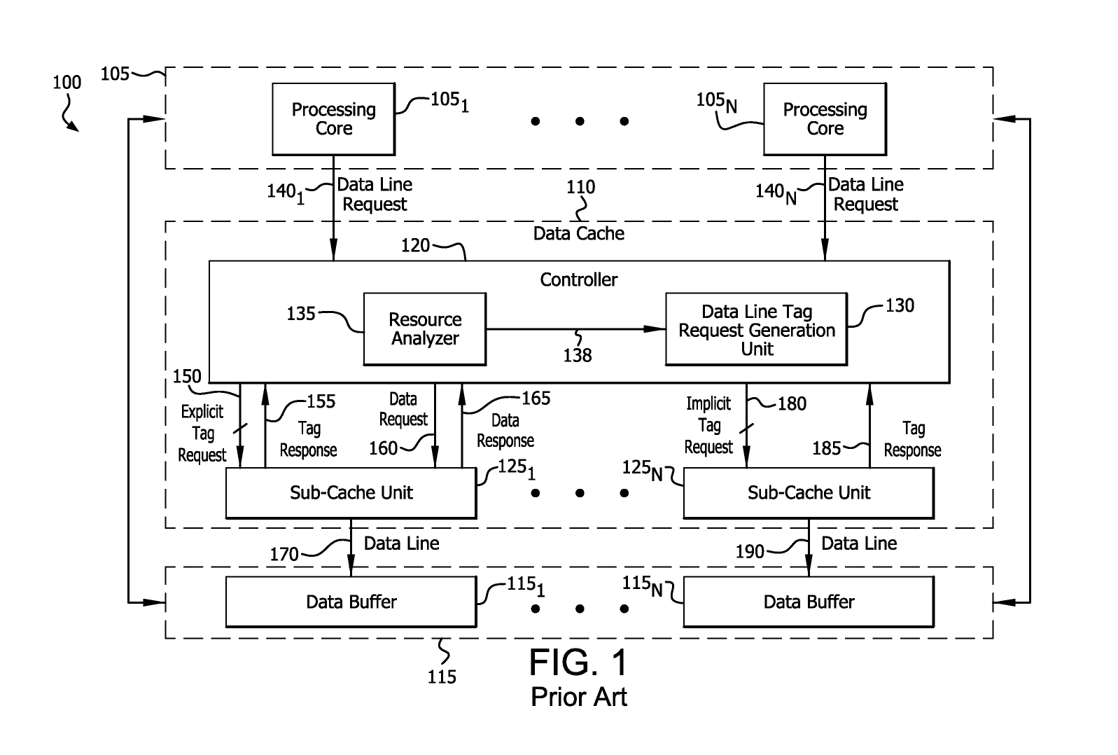

FIG. 2 shows a processor that generates explicit and implicit data line tag requests by predicting data resource availability in accordance with the present invention; and

FIG. 3 is a flow diagram of a procedure for generating data line tag requests in accordance with the present invention.

### DETAILED DESCRIPTION

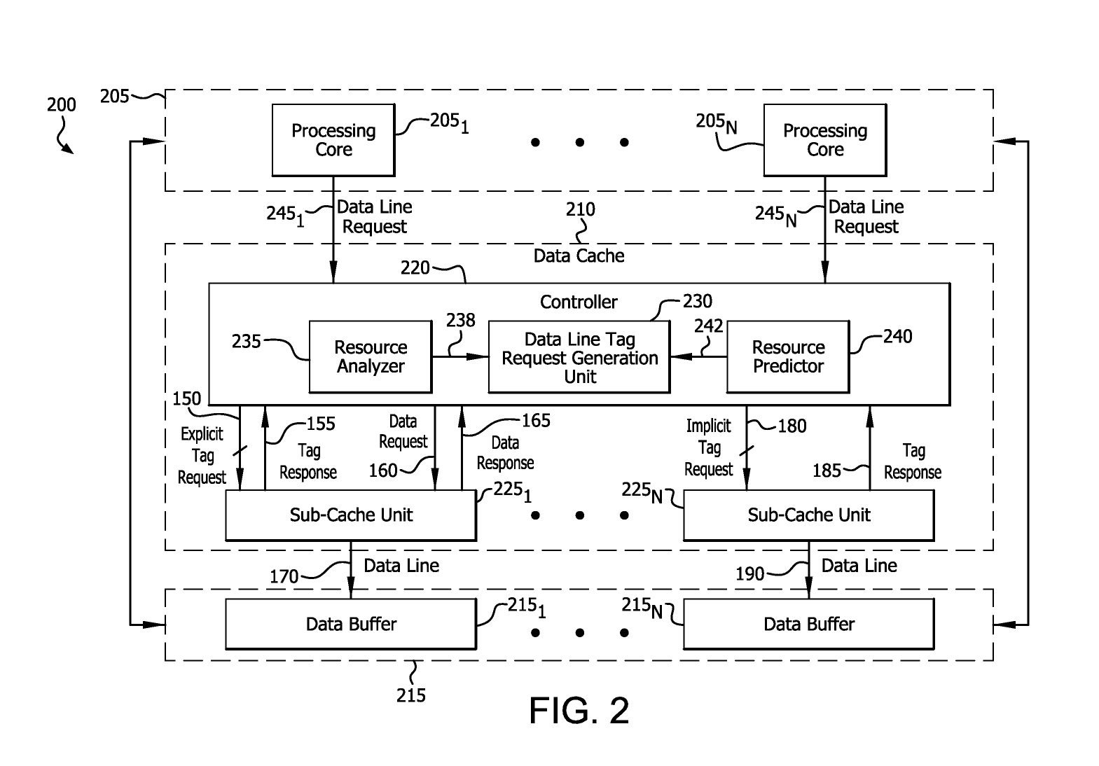

FIG. 2 shows a processor 200 that generates explicit and implicit data line tag requests in accordance with the present invention. The processor 200 includes processing cores 2051-205N, a data cache 210 and data buffers 2151-215N. The data cache 210 includes a controller 220 and sub-cache units 2251-225N. The controller 220 includes a data line tag request generation unit 230, a resource analyzer 235 and a resource predictor 240.

The data line tag request generation unit 230 is configured to output a data line tag request in response to the controller 220 in the data cache 210 receiving a data line request 245 from any of the processing cores 205. The data line tag request may consist of an address of a requested data line and an indicator (e.g., represented by one or more bits) of whether the tag request is to be an explicit tag request or an implicit tag request.

The resource analyzer 235 monitors data resources and constantly indicates to the data line tag request generation unit 230 via a signal 238 whether or not there are currently sufficient data resources to immediately generate a tag request with an implicit indicator to perform an implicit data line read. However, in accordance with the present invention, the generation of tag requests may be delayed in response to a signal 242 generated by the resource predictor 240, which estimates a time period before sufficient data resources will become available in the future, and compares the estimated time period to a predetermined (e.g., programmable) threshold. Thus, even if the resource analyzer 235 determines that sufficient data resources are not currently available to immediately generate a tag request with an implicit indicator, the resource predictor 240 may send a signal 242 to the data line tag request generation unit 230 that delays the generation of a tag request until sufficient data resources are available, if the estimated time period is determined by the resource predictor 240 to be equal to or less than the predetermined threshold. When sufficient data resource become available, a tag request with an implicit indicator to perform an implicit data line read is generated.

The resources that need to be examined by the resource predictor 240 may include the availability of data buses in each sub-cache unit 225. Because each data line read from the sub-cache units 225 requires multiple clock cycles to complete (e.g., 4), the scheduling of overlapping data requests should be minimized or avoided altogether. The resource predictor 240 also needs to examine the availability of the data buffers 215 associated with the respective sub-cache units 225. The data retrieved in response to the tag requests is stored in reserved memory addresses of the data buffers 215 after it is read, until the processing core 205 that requested the data is ready to receive it.

The resource predictor 240 also needs to examine storage element availability. The data in each sub-cache unit 225 is organized as multiple storage elements. Even though two buses may be used for returning data, each storage element may only have one operation in progress at any time.

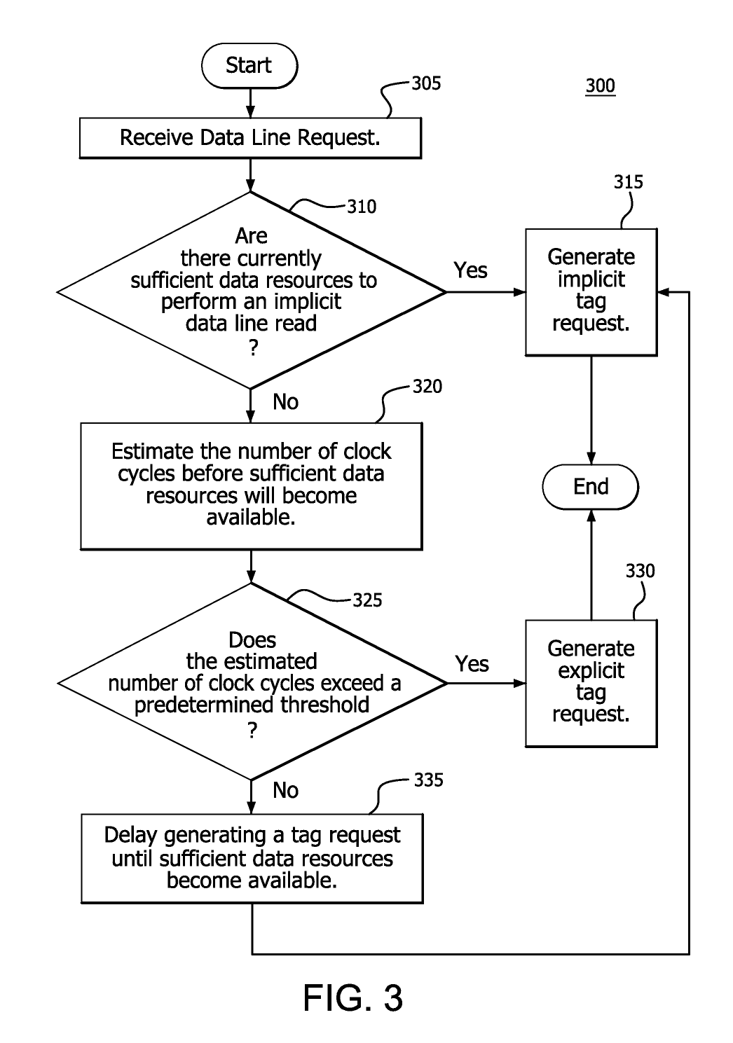

FIG. 3 is a flow diagram of a procedure 300 for generating data line tag requests in accordance with the present invention. In step 305, a data line request is received (e.g., from a processing core). In step 310, a determination is made as to whether there are currently sufficient data resources to perform an implicit data line read in response to receiving the data line request. If the determination made in step 310 is positive, an implicit tag request is generated (step 315). If the determination made in step 310 is negative, the number of clock cycles before sufficient data resources will become available to perform an implicit data line read is estimated (step 320). In step 325, a determination is made as to whether the estimated number of clock cycles exceed a predetermined threshold. If the determination made in step 325 is positive, an explicit tag request is generated (step 330). If the determination made in step 325 is negative, the generation of a tag request is delayed until sufficient data resources become available (step 335). An implicit tag request is then generated (step 315).

Although features and elements are described above in particular combinations, each feature or element can be used alone without the other features and elements or in various combinations with or without other features and elements. The apparatus described herein may be manufactured using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of selectively performing explicit and implicit data line reads comprising:
if there are not currently sufficient data resources to perform an implicit data line read responsive to a received data line request, estimating a time period before sufficient data resources will become available to perform an implicit data line read.

2. The method of claim 1 wherein the estimated time period is equal to a number of clock cycles.

3. The method of claim 1 further comprising:
determining whether the estimated time period exceeds a threshold; and
generating an explicit tag request if the estimated time period exceeds the threshold.

4. The method of claim 1 further comprising:
determining whether the estimated time period exceeds a threshold;
delaying the generation of a tag request until sufficient data resources become available; and
generating an implicit tag request.

5. The method of claim 1 wherein the estimated time period is determined based on the availability of data buses in each of a plurality of sub-cache units of a cache that receives the data line request.

6. The method of claim 5 wherein the estimated time period is determined based on the availability of data buffers associated with respective ones of the sub-cache units.

7. The method of claim 1 wherein the estimated time period is determined based on storage element availability.

8. A semiconductor device comprising:
a cache including a controller configured to receive a data line request, and estimate a time period before sufficient data resources will become available to perform an implicit data line read if there are not currently sufficient data resources to perform an implicit data line read responsive to a received data line request.

9. The semiconductor device of claim 8 wherein the estimated time period is equal to a number of clock cycles.

10. The semiconductor device of claim 8 wherein the controller is further configured to determine whether the estimated time period exceeds a threshold, and generate an explicit tag request if the estimated time period exceeds the threshold.

11. The semiconductor device of claim 8 wherein the controller is further configured to determine whether the estimated time period exceeds a threshold, delay the generation of a tag request until sufficient data resources become available, and generate an implicit tag request.

12. The semiconductor device of claim 8 wherein the cache further includes a plurality of sub-cache units, and the estimated time period is determined based on the availability of data buses in each of the sub-cache units.

13. The semiconductor device of claim 12 wherein the estimated time period is determined based on the availability of data buffers associated with respective ones of the sub-cache units.

14. The semiconductor device of claim 8 wherein the estimated time period is determined based on storage element availability.

15. The semiconductor device of claim 8 further comprising:
a plurality of processing cores coupled to the cache, each processing core being configured to generate a data line request.

16. A semiconductor device including a computer-readable medium containing a set of instructions for selectively performing explicit and implicit data line reads, the set of instructions comprising:
an instruction for estimating a time period before sufficient data resources will become available to perform an implicit data line read if there are not currently sufficient data resources to perform an implicit data line read responsive to a received data line request.

17. The semiconductor device of claim 16 wherein the instructions are Verilog data instructions.

18. The semiconductor device of claim 16 wherein the instructions are hardware description language (HDL) instructions.

19. A computer-readable storage medium configured to store a set of instructions used for manufacturing a semiconductor device, wherein the semiconductor device comprises:
a cache including a controller configured to receive a data line request, and estimate a time period before sufficient data resources will become available to perform an implicit data line read if there are not currently sufficient data resources to perform an implicit data line read responsive to a received data line request.

20. The computer-readable storage medium of claim 19 wherein the instructions are Verilog data instructions.

21. The computer-readable storage medium of claim 19 wherein the instructions are hardware description language (HDL) instructions.
